(19) United States
(12) Patent Application Publication
(10) Pub. No.: US 2005/0286481 A1
(43) Pub. Date: Dec. 29, 2005

(54) Method for data transmission utlizing a portable multimedia device

(76) Inventor: Anthony M. Fadell, Portola Valley, CA (US)

Correspondence Address: BEYER WEAVER & THOMAS LLP, P.O. BOX 70250, OAKLAND, CA, 94612-0250, US

(21) Appl. No.: 10/881,484

(22) Filed: Jun. 29, 2004

(51) Int. Cl. H04B 7/216

(52) U.S. Cl. 370/342

(57) ABSTRACT

A communication system for sending data between a multimedia player and a nearby receiver is described. In the described embodiment, the multimedia player includes a multimedia data file processor unit arranged to process a multimedia data file and a data transmission unit coupled to the multimedia data file processor unit arranged to concurrently transmit selected portions of the processed multimedia data file. The system also includes a nearby receiver unit capable of receiving the transmitted selected portions of the processed multimedia data file.

### FIELD OF INVENTION

This invention relates generally to remote communication devices such as multimedia players, cell phones, radios (either mobile or stationary) and personal digital assistants. More specifically, the invention describes a method and apparatus for wirelessly transmitting digital media data and any related information between any of a number of such communication devices.

### DESCRIPTION OF RELATED ART

Recent developments in consumer electronics have included the introduction of remote client devices such as portable multimedia players (such as MP3 players, minidisk players), cell phones, personal digital assistants (PDAs) and the like.

For example, in the case of an MP3 player (or, for that matter, any other digital media playback device), a number of digitized audio files are stored in a storage medium included in or coupled to the player in a fashion deemed most suitable to that user. In the case of MP3 files, for example, a user of the MP3 player must be able to conveniently interact with the player in order to peruse and select a particular file (or files) based upon such characteristics as music genre, author, album, or whatever grouping of MP3 files is present in the MP3 player. In addition to merely selecting a particular file, it would be of great convenience to the user to be able to listen to the selected MP3 file and read any associated information on a receiver unit, such as a car radio, that is separate and distinct from the player itself.

Therefore, what is desired is a convenient way for a user to concurrently listen to a selected digital multimedia file and view any associated information pertaining to the multimedia file.

### SUMMARY OF THE INVENTION

A communication system for sending data between a multimedia player and a nearby receiver is described. In the described embodiment, the multimedia player includes a multimedia data file processor unit arranged to process a multimedia data file and a data transmission unit coupled to the multimedia data file processor unit arranged to concurrently transmit selected portions of the processed multimedia data file. The system also includes a nearby receiver unit capable of receiving the transmitted selected portions of the processed multimedia data file.

In one embodiment, the multimedia data file is a digital media file in any of a number of digital media formats whilst the multimedia player takes the form of a pocket sized, portable digital media file player, such as an iPod™ manufactured by Apple Computer Corporation of Cupertino, Calif. In a preferred embodiment, the receiver unit is compatible with Radio Data System (RDS) embodied in what is commonly referred to as an RDS enabled “smart” radio.

In another embodiment, the multimedia player wirelessly transmits the processed multimedia data file to the receiver while in another embodiment, the multimedia player is wired directly to the receiver unit.

### BRIEF DESCRIPTION OF THE DRAWINGS

The invention will be better understood by reference to the following description taken in conjunction with the accompanying drawings.

FIGS. 1A-1B each show an of embodiment of a communication system in accordance with the invention.

FIG. 2 shows an exemplary portable multimedia device, or media player, 200 in accordance with an embodiment of the invention.

FIG. 3 shows a particular implementation of the user input device 208 having a number of input buttons in accordance with an embodiment of the invention.

FIG. 4 shows a flowchart detailing a process for wirelessly transmitting a decoded multimedia data file (such as an MP3 file in the case of music) and an associated information data file in accordance with an embodiment of the invention.

FIG. 5 illustrates a system employed to implement the invention.

### DETAILED DESCRIPTION OF SELECTED EMBODIMENTS

Reference will now be made in detail to a preferred embodiment of the invention. An example of the preferred embodiment is illustrated in the accompanying drawings. While the invention will be described in conjunction with a preferred embodiment, it will be understood that it is not intended to limit the invention to one preferred embodiment. To the contrary, it is intended to cover alternatives, modifications, and equivalents as may be included within the spirit and scope of the invention as defined by the appended claims.

A number of embodiments of the invention incorporate a receiver unit compatible with the Radio Data System (RDS) that sends extra information along with VHF/FM radio services to suitable receiving equipment without affecting the normal audio program. The basic concept behind RDS is that each FM radio station is given a set bandwidth can be used for it's broadcasting. However, most stations do not use all of their bandwidth, and the spare bandwidth is usually wasted. Therefore, RDS uses this wasted bandwidth for transmitting a low bit rate FM radio based data signal by being modulated into the radio station signal and transmitted along side it. This arrangement is very cost effective since the existing transmitting towers can be used with very little modification.

The invention described herein pertains to a method, apparatus, and system that affords a user of a remote communication device, such as a multimedia player (along the lines of an IPOD™ multimedia player manufactured by Apple Computer Corporation of Cupertino, Calif.) the ability to conveniently send audio and/or associated textual information either wired or wirelessly to a compatible receiver unit (such as, for example, a Radio Data System (RDS) enabled radio).

In one embodiment, a multimedia player in combination with a wireless data transmission unit transmits both media data and text data (either associated with the media data or not as deemed appropriate for the particular situation) to a nearby receiver device arranged to receive and process as needed either one or the other or both the media data and text data concurrently. It should be noted that the multimedia player can take the form the iPod™ player coupled with an FM transmitter adapter to wirelessly transmit media data (i.e., songs, music, etc.) and its related information (e.g., song title, title artist, etc) using Radio Data Service (RDS) based data bitstream to an appropriately configured receiver (such as an RDS enabled radio, often referred to as a “smart radio”). In this way, a user can in addition to selecting a particular song or music selection, be provided with information (such as artist) directly related to the selected musical selection. For example, a user can use the available music data to select only certain artists, or only music having certain titles, etc. thereby greatly enhancing the user's listening experience.

In another embodiment, a communication system having a multimedia player directly wired to a receiver unit is described that is useful in those situations where transmitting data wirelessly to the receiver unit is either impracticable or infeasible. In yet another embodiment, the multimedia player can be configured to operate in either a wireless mode or a wired mode as selected by a user based upon the situation at hand.

In a particular embodiment, the multimedia player is a pocket sized, multimedia device (personal digital assistants, personal media player/recorders, and the like) having a display screen and a user input device that is typically formed of a manually operated switch, button, wheel, or other such contrivances. By manipulating the input device, a user is able to select a particular multimedia file for play along with an associated data file. In the case of a digital audio file (such as a music), the associated data file can include such information as the song title, author, length of play, and other such useful information. Once a particular MP3 file has been selected, the player decodes the selected MP3 file and wirelessly transmits the decoded music file and associated data file by way of a radio transmitter unit coupled thereto. In the described embodiment, an RDS enabled radio both broadcasts the music on a speaker and displays the associated data on a display that contains such information as title, author, and the like. Once selected, the remote player decodes and plays the selected music file and displays the associated data file and if so desired, will wirelessly transmit same the music file and associated data file to an appropriately configured receiver device such as an RDS enable radio.

The invention will now be described in terms a portable multimedia player capable of storing a number of multimedia data files. For example, in the case of the multimedia player being a pocket sized portable player (such as the IPOD™ player manufactured by the Apple Computer Inc. of Cupertino, Calif.), the multimedia data files can include MP3 files as well as any other appropriately data files.

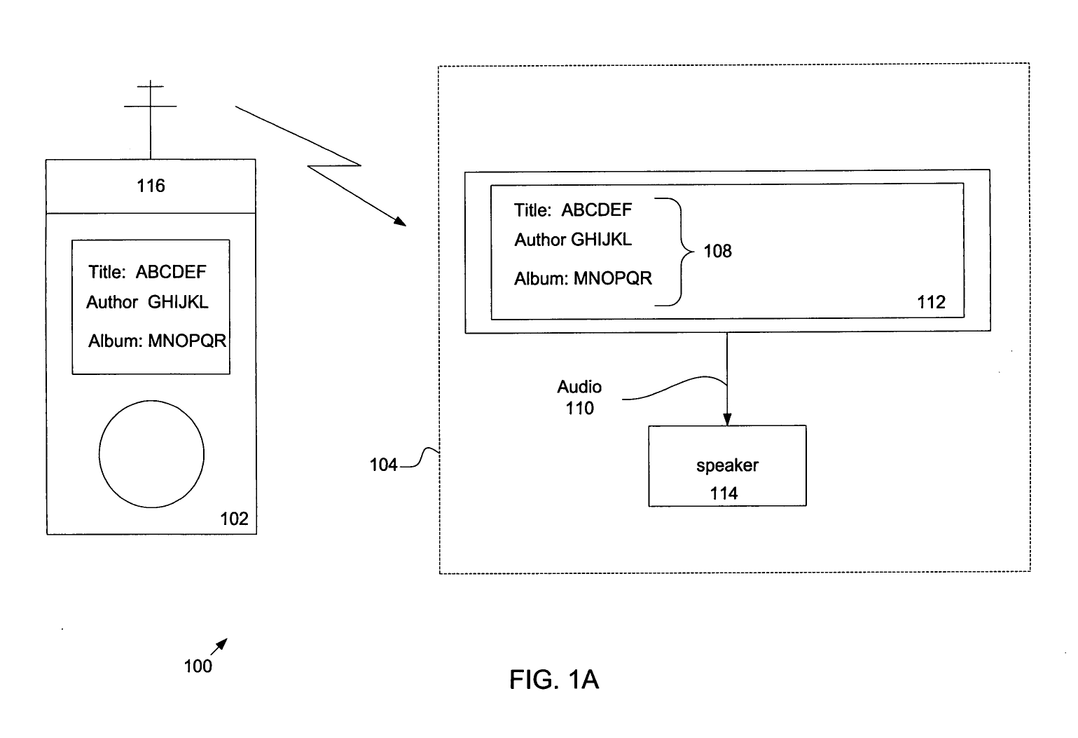

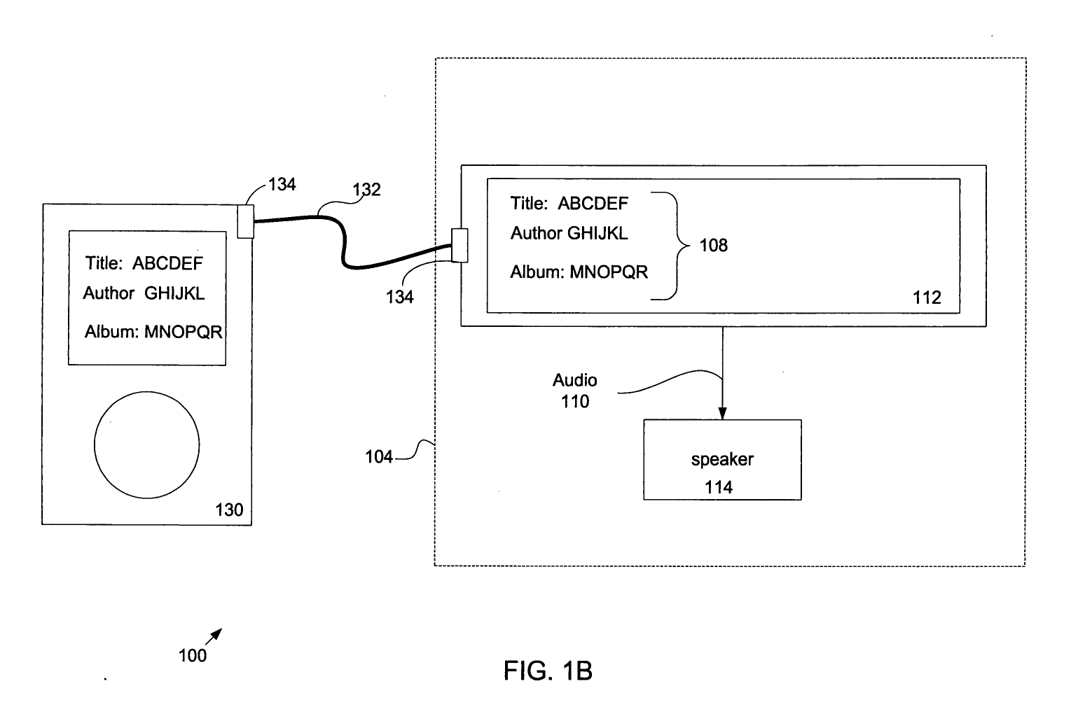

Accordingly, FIG. 1A shows a system 100 suitable for wirelessly transmitting data from a pocket sized multimedia player 102 in accordance with an embodiment of the invention. In the system 100, the multimedia player 102 is in wireless communication with a receiving unit 104 capable of selectively displaying graphical and/or textual information 108 simultaneously with an associated audio 110. In the described embodiment, the receiving unit 104 is an RDS enabled radio having a display 112 for displaying the information 108 and a speaker 114 for broadcasting the audio. Typically, the radio 104 is found in any number of modes of transportation such as automobiles, SUVs, etc. or any other situation where nearby placement of the player 102 is feasible.

During operation, a user selects any of a number of multimedia data files stored within the multimedia player 102. Accordingly, the user can thereby choose to listen to the selected multimedia data file by way of an attached headphone (not shown) or in the case when, for example, the user is traveling in an automobile, the user can choose to transmit both the audio and associated information (title, author, track number, etc.) by way of a wireless transmitter unit 116 coupled to or incorporated within the player 102. In the described embodiment, the wireless transmitter unit 116 takes the form of an RDS FM radio transmitter unit 116 capable of wirelessly communicating with the RDS enabled radio 104. In this way, the user can both listen to the selected file as well as read relevant information pertinent to the selected music file. Such relevant information includes song title, song author, and album title along with any number of other information that the user may find useful.

FIG. 1B shows another embodiment of the invention whereby a multimedia player 130 is wired directly to the receiver unit by way of a connector 132 utilizing input jacks 134. It should be noted, that although not explicitly shown in either FIG. 1A or FIG. 1B, a modified version of the multimedia player can used to send data in either a wireless manner or a wired manner as selected by a user thereby affording the advantages of both. In this case, the FM transmitter unit is deactivated when the connector is inserted to the corresponding input jack and vice versa.

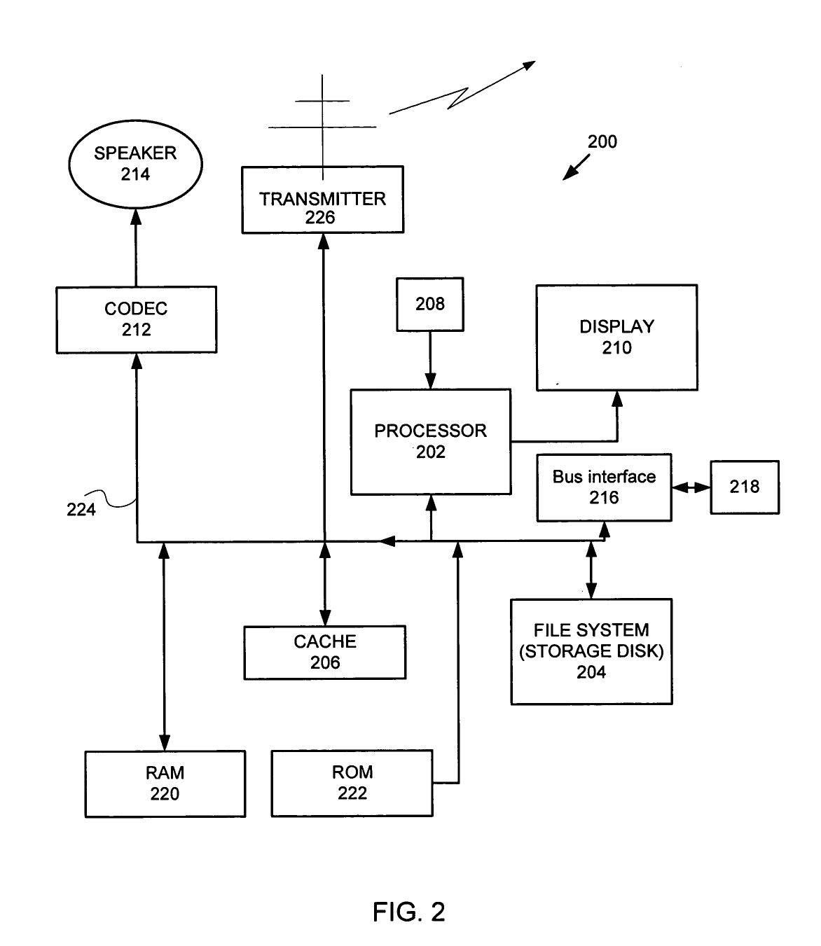

FIG. 2 shows an exemplary portable multimedia player 200 in accordance with an embodiment of the invention. The media player 200 includes a processor 202 that pertains to a microprocessor or controller for controlling the overall operation of the media player 200. The media player 200 stores media data pertaining to media files in a file system 204 and a cache 206. The file system 204 is, typically, a storage disk or a plurality of disks. The file system 204 typically provides high capacity storage capability for the media player 200. However, since the access time to the file system 204 is relatively slow, the media player 200 can also include a cache 206. The cache 206 is, for example, Random-Access Memory (RAM) provided by semiconductor memory. The relative access time to the cache 206 is substantially shorter than for the file system 204. However, the cache 206 does not have the large storage capacity of the file system 204. Further, the file system 204, when active, consumes more power than does the cache 206. The power consumption is particularly important when the media player 200 is a portable media player that is powered by a battery (not shown). The media player 200 also includes a RAM 220 and a Read-Only Memory (ROM) 222. The ROM 222 can store programs, utilities or processes to be executed in a non-volatile manner. The RAM 220 provides volatile data storage, such as for the cache 206.

The media player 200 also includes a user input device 208 that allows a user of the media player 200 to program any individual (or combination) interact with the media player 200. Still further, the media player 200 includes a display 210 (screen display) that can be controlled by the processor 202 to display information to the user. A data bus 224 facilitates data transfer between at least the file system 204, the cache 206, the processor 202, and the CODEC 210 and a wireless transmitter unit 226. The media player 200 also includes a bus interface 216 that couples to a data link 218 that allows the media player 200 to couple to a host computer.

In one embodiment, the media player 200 serves to store a plurality of media files (e.g., songs) in the file system 204. When a user desires to have the media player play a particular media item, a list of available media files is displayed on the display 210. Then, using the user input device 208, a user can select one of the available media files. The processor 202, upon receiving a selection of a particular media item, supplies the media data (e.g., audio file) for the particular media item to a coder/decoder (CODEC) 210. The CODEC 212 then produces analog output signals for a speaker 214. The speaker 214 can be a speaker internal to the media player 200 or external to the media player 200. For example, headphones or earphones that connect to the media player 200 would be considered an external speaker.

As configured, the media player 200 includes the wireless transmitter unit 226 arranged to wirelessly transmit any selected data from the media player 200 to any appropriately configured receiver unit. In the case where the wireless transmitter unit 226 is an RDS RF transmitter unit, any selected music and or associated data file can be communicated concurrently from the player 200 to an RDS enabled receiver unit. In this way, both the music and associated data (such as the information 108) can be broadcast and displayed concurrently by the receiver unit 104 thereby affording the user the ability to both listen to a selected music file and read appropriate text describing various aspects of the selected music file.

In one embodiment, the media player 200 is a portable computing device dedicated to processing media such as audio. For example, the media player 200 can be a music player (e.g., MP3 player), a game player, and the like. These devices are generally battery operated and highly portable so as to allow a user to listen to music, play games or video, record video or take pictures wherever the user travels. In one implementation, the media player 200 is a handheld device that is sized for placement into a pocket or hand of the user. By being handheld, the media player 200 is relatively small and easily handled and utilized by its user. By being pocket sized, the user does not have to directly carry the device and therefore the device can be taken almost anywhere the user travels (e.g., the user is not limited by carrying a large, bulky and often heavy device, as in a portable computer). Furthermore, the device may be operated by the users hands, no reference surface such as a desktop is needed.

In a particular embodiment, the available media files are arranged in a hierarchical manner based upon a selected number and type of groupings appropriate to the available media files. For example, in the case where the media player 200 is an MP3 type media player, the available media files take the form of MP3 files (each of which corresponds to a digitally encoded song or other audio rendition) stored at least in part in the file system 204. The available media files (or in this case, songs) can be grouped in any manner deemed appropriate. In one arrangement, the songs can be arranged hierarchically as a list of music genres at a first level, a list of artists associated with each genre at a second level, a list of albums for each artist listed in the second level at a third level, while at a fourth level a list of songs for each album listed in the third level, and so on. This hierarchical ordering can therefore be displayed both on the media player display 210 as well as the display 112 associated with the RDS enabled radio 104. In addition, any changes to the display 210 will also be reflected almost immediately on the display 112 in accordance with a user input event presented by the user input device 208. In this way, the user input device 208 can be used to remotely change the information displayed on the display 112.

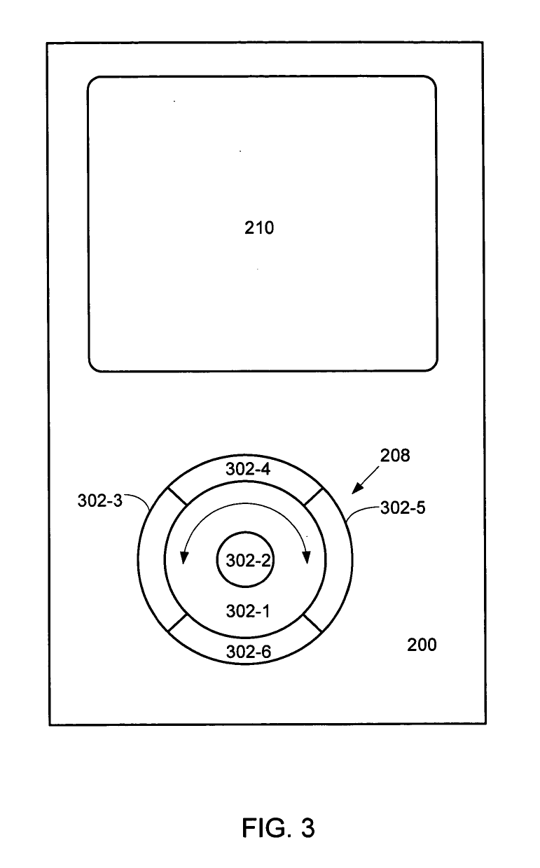

The user input device 208 can take a variety of forms, such as a button, keypad, dial, etc. each of which can be programmed to individually or in combination to perform any of a suite of functions. FIG. 3 shows a particular implementation of the user input device 208 having a number of input buttons 302. Such input buttons 302 take the form of a rotatable dial 302-1 in the form of a wheel capable of rotation in either a clockwise or counterclockwise direction having at its center an depressable input button 302-2 arranged to receive a user input event such as a press event. Other input buttons 302 include input buttons 302-3 through 302-6 each available to receive user supplied input action.

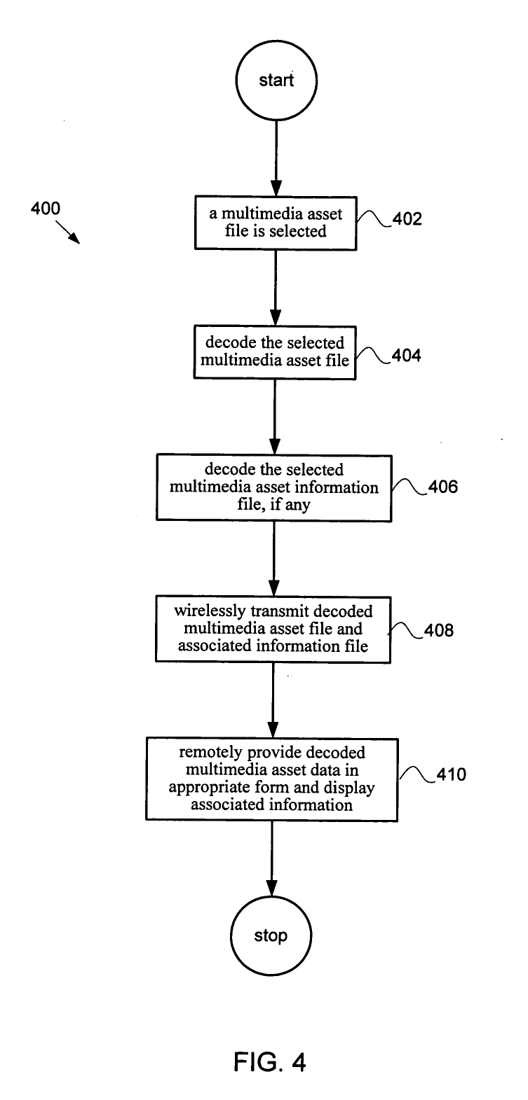

FIG. 4 shows a flowchart detailing a process 400 for wirelessly transmitting a decoded multimedia data file and an associated information data file in accordance with an embodiment of the invention. At 402, a multimedia data file is selected at a portable pocket sized player device, such as an iPOD manufactured by Apple Computer of Cupertino Calif. The player then decodes the selected multimedia data file associated with an appropriately encoded music or song selection at 404 concurrently with decoding an associated multimedia information file at 406. In the described embodiment, the multimedia information file includes such information as artist, title, album, data of recording, etc. in those cases when the associated multimedia data file is an MP3 file, or the like. At 408, the decoded data file and associated information file is wirelessly transmitted to a nearby appropriately configured receiver unit. Typically, the player will provide an RDS FM signal to the receiver configured as an RDS enabled radio included in, for example, a mode of transport such as an automobile. At 410, the receiver unit concurrently broadcasts the selected audio file (such as a song, instrumental, spoken word, etc.) over a loudspeaker with displaying the associated information file on a display unit coupled thereto.

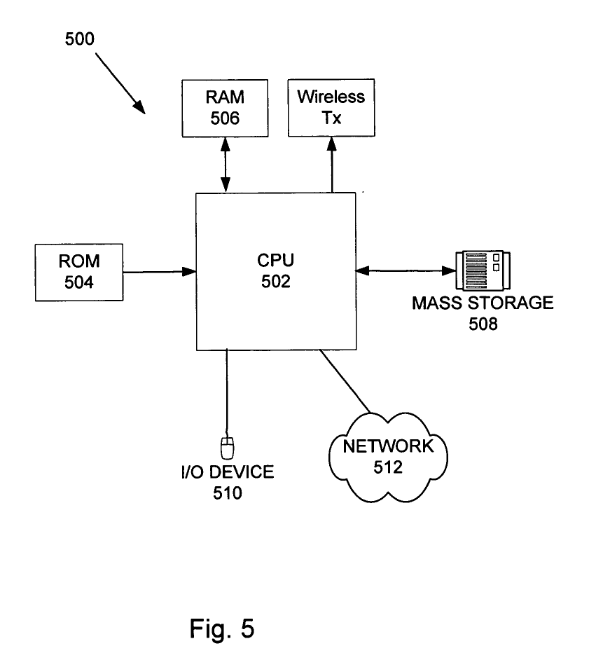

FIG. 5 illustrates a computer system 500 employed to implement the invention. The computer system 500 or, more specifically, CPU 502, may be arranged to support a virtual machine, as will be appreciated by those skilled in the art. As is well known in the art, ROM acts to transfer data and instructions uni-directionally to the CPU 502, while RAM is used typically to transfer data and instructions in a bi-directional manner. CPU 502 may generally include any number of processors. Both primary storage devices 504, 506 may include any suitable computer-readable media. A secondary storage medium 508, which is typically a mass memory device, is also coupled bi-directionally to CPU 502 and provides additional data storage capacity. The mass memory device 508 is a computer-readable medium that may be used to store programs including computer code, data, and the like. Typically, mass memory device 508 is a storage medium such as a hard disk or a tape which generally slower than primary storage devices 504, 506. Mass memory storage device 508 may take the form of a magnetic or paper tape reader or some other well-known device. It will be appreciated that the information retained within the mass memory device 508, may, in appropriate cases, be incorporated in standard fashion as part of RAM 506 as virtual memory. A specific primary storage device 504 such as a CD-ROM may also pass data uni-directionally to the CPU 502.

CPU 502 are also coupled to one or more input/output devices 510 that may include, but are not limited to, devices such as video monitors, track balls, mice, keyboards, microphones, touch-sensitive displays, transducer card readers, magnetic or paper tape readers, tablets, styluses, voice or handwriting recognizers, or other well-known input devices such as, of course, other computers. Finally, CPU 502 optionally may be coupled to a computer or telecommunications network, e.g., an Internet network or an intranet network, using a network connection as shown generally at 512. With such a network connection, it is contemplated that the CPU 502 might receive information from the network, or might output information to the network in the course of performing the above-described method steps. Such information, which is often represented as a sequence of instructions to be executed using CPU 502, may be received from and outputted to the network, for example, in the form of a computer data signal embodied in a carrier wave. The above-described devices and materials will be familiar to those of skill in the computer hardware and software arts. The various aspects or features of the invention described above can be used alone or in various combinations.

Although the media items of emphasis in several of the above embodiments where audio items (e.g., audio files or songs), the media items are not limited to audio items. For example, the media item can alternatively, pertain to recorded discussions and the like.

The invention is preferably implemented by software, but can also be implemented in hardware or a combination of hardware and software. The invention can also be embodied as computer readable code on a computer readable medium. The computer readable medium is any data storage device that can store data which can thereafter be read by a computer system. Examples of the computer readable medium include read-only memory, random-access memory, CD-ROMs, DVDs, magnetic tape, optical data storage devices, and carrier waves. The computer readable medium can also be distributed over network-coupled computer systems so that the computer readable code is stored and executed in a distributed fashion.

The many features and advantages of the present invention are apparent from the written description and, thus, it is intended by the appended claims to cover all such features and advantages of the invention. Further, since numerous modifications and changes will readily occur to those skilled in the art, the invention should not be limited to the exact construction and operation as illustrated and described. Hence, all suitable modifications and equivalents may be resorted to as falling within the scope of the invention.

While this invention has been described in terms of a preferred embodiment, there are alterations, permutations, and equivalents that fall within the scope of this invention. It should also be noted that there are many alternative ways of implementing both the process and apparatus of the present invention. It is therefore intended that the invention be interpreted as including all such alterations, permutations, and equivalents as fall within the true spirit and scope of the present invention.

1. A communication system, comprising:
a multimedia player comprising:
a multimedia data file processor unit arranged to process a multimedia data file, and
a data transmission unit coupled to the multimedia data file processor unit arranged to concurrently transmit selected portions of the processed multimedia data file; and
a nearby receiver unit capable of receiving the transmitted selected portions of the processed multimedia data file.

2. A communication system as recited in claim 1, wherein the processed multimedia data file includes an audio portion and an associated information portion.

3. A communication system as recited in claim 2, wherein the transmission unit is a wireless transmission unit capable of wirelessly transmitting the audio portion and the information portion concurrently to the receiver unit.

4. A communication system as recited in claim 2 wherein the data transmission unit is a wired transmission unit capable of wired transmission of the audio portion and the information portion concurrently to the receiver unit.

5. A communication system as recited in claim 2 wherein the data transmission unit includes a wireless transmission portion and a wired transmission portion each of which is capable of transmitting the selected portions concurrently from the multimedia player to the receiver unit.

6. A communication system as recited in claim 1, wherein the multimedia data file is a digital audio file.

7. A communication system as recited in claim 2 further comprising:
a display screen coupled to the processor unit arranged to display the information portion; and
a user input unit coupled to the processor unit arranged to provide any of a number of user input commands that are, in turn, executed by the processor unit.

8. A communication system as recited in claim 6, wherein the multimedia data file processor includes a digital data file decoder sub-processor unit arranged to decode the digital data file to form a corresponding audio file and an associated information file.

9. A communication system as recited in claim 3, wherein the wireless transmission unit is a FM radio transmitter unit arranged to concurrently transmit a decoded digital audio file and the associated information file.

10. A communication system as recited in claim 9, wherein the receiver unit includes a receiver unit display screen and a receiver unit speaker.

11. A communication system as recited in claim 10, wherein the information is displayed on the receiver unit display screen concurrently with the audio file being broadcast by the speaker.

12. A communication system as recited in claim 11, wherein the receiver unit is an RDS enabled “smart radio”.

13. A device for wirelessly transmitting data, comprising:
a multimedia data file processor unit arranged to process a multimedia data file; and
a wireless transmission unit coupled to the multimedia data file processor unit arranged to concurrently transmit selected portions of the processed multimedia data file.

14. The device as recited in claim 13, further comprising:
a display screen coupled to the processor unit arranged to display information related to the selected multimedia data file; and
a user input unit coupled to the processor unit arranged to provide any of a number of user input commands that are, in turn, executed by the processor unit.

15. The device as recited in claim 14, wherein the multimedia data file processor includes an MP3 decoder sub-processor unit arranged to decode an MP3 file to form a corresponding audio file and an associated information file.

16. The device as recited in claim 15, wherein the multimedia data file is an MP3 file and an associated information data file.

17. The device as recited in claim 16, wherein the wireless transmission unit is an RDS enabled FM radio transmitter unit arranged to concurrently transmit a decoded MP3 file and the associated information file.

18. The device as recited in claim 17, wherein the device wirelessly transmits the audio file and the associated information concurrently to a nearby RDS enabled receiver unit that includes a receiver unit display screen and a receiver unit speaker.

19. The device as recited in claim 18, wherein the information is displayed on the receiver unit display screen concurrently with the audio file being broadcast by the speaker.

20. The device as recited in claim 19, wherein when a user input command is executed by the processor unit results in a changed display on the display screen, then the changed display concurrently displayed on the receiver unit display screen.

21. The device as recited in claim 20, wherein the device is a cellular telephone or a Personal Digital Assistant (PDA) or paging device or an MP3 player.

22. The device as recited in claim 21, wherein the MP3 player is an iPod MP3 player.

23. A method for data transmission between a multimedia player and a nearby receiver, comprising:
processing a multimedia file by the multimedia player into a first portion and an associated information portion;
concurrently transmitting selected portions of the processed multimedia file from the multimedia player to the receiver;
broadcasting the first portion by the receiver; and
concurrently with the broadcasting, displaying the association information portion.

24. The method as recited in claim 23, wherein the first portion is an audio file.

25. The method as recited in claim 24, wherein when the multimedia data file is an MP3 file and an associated information data file, then decoding the MP3 file to form a corresponding audio file and the associated information file.

26. The method as recited in claim 25, wherein the wireless transmission unit is an RDS enabled FM radio transmitter unit arranged to concurrently transmit a decoded MP3 file and the associated information file.

27. The method as recited in claim 26, wherein the device wirelessly transmits the audio file and the associated information concurrently to a nearby receiver unit that includes a receiver unit display screen and a receiver unit speaker.

28. The method as recited in claim 27, wherein the information is displayed on the receiver unit display screen concurrently with the audio file being broadcast by the speaker.

29. The method as recited in claim 28, wherein when a user input command is executed by the processor unit results in a changed display on the display screen, then the changed display concurrently displayed on the receiver unit display screen.

30. The method as recited in claim 29, wherein the device is a cellular telephone or a Personal Digital Assistant (PDA) or paging device or an MP3 player.
